(19) United States
(12) Patent Application Publication
(10) Pub. No.: US 2007/0116338 A1
(43) Pub. Date: May 24, 2007

(54) Methods and systems for automatic segmentation of biological structure

(75) Inventors: Marta Fidrich, Szeged (HU); Gyorgy Bekes, Melykut (HU); Eors Mate, Szeged (HU)

Correspondence Address: MCANDREWS HELD & MALLOY, LTD, 500 WEST MADISON STREET, SUITE 3400, CHICAGO, IL, 60661, US

(73) Assignee: General Electric Company

(21) Appl. No.: 11/491,434

(22) Filed: Jul. 21, 2006

Related U.S. Application Data
(60) Provisional application No. 60/739,695, filed on Nov. 23, 2005.
(60) Provisional application No. 60/739,691, filed on Nov. 23, 2005.

(51) Int. Cl. G06K 9/00; G06K 9/34

(52) U.S. Cl. 382/128; 382/173

(57) ABSTRACT

Certain embodiments of the present invention provide a method for segmenting biological structure including: identifying at least one seed point associated with a radiographic image, wherein the radiographic image includes one or more organs of sight, the at least one seed point positioned to correspond to an interior region of at least one of the one or more organs of sight; and automatically segmenting at least one of the one or more organs of sight based at least in part on the at least one seed point. In an embodiment, the at least one of the one or more organs of sight includes at least one eyeball. In an embodiment, automatically segmenting the at least one eyeball further includes: identifying a center point of the eyeball; locating a sphere having a predefined radius at the center point; adjusting the sphere to substantially conform to processed data along an expected surface of the eyeball.

### BACKGROUND OF THE INVENTION

Embodiments of the present application relate generally segmentation of biological structure. Particularly, certain embodiments relate to automatic segmentation of organs of sight.

Segmentation of biological structure is becoming increasingly important area in medicine. A variety of clinical applications may employ segmentation of biological structure. As an example, planning for surgery may benefit from segmentation. As a further example, an oncologist or other clinician may treat cancer with radiation therapy (“RT”) by delivering an amount of radiation to diseased tissue. While focusing the radiation dose towards the target tissues, the avoidance of nearby structures may also be a goal. In the case of head and neck RT, the organs at risk may include the lens in the eye. Additionally, nervous tissue (e.g. brain, optic nerve, spinal cord) may also be sensitive to radiogenic effects.

Radiological imaging, such as computed tomography (“CT”) and magnetic resonance imaging (“MRI”) scans, may be used as anatomical models to assist delivery of an RT dose to a specific region of a patient. Segmentation may be carried out manually. For example, a radiologist may trace outline(s) of biological structures with an image editing/display program to accomplish segmentation manually. When three-dimensional segmentation is required, manual segmentation may entail tracing segmentation contours on a number of two-dimensional slices and then combining the traces to arrive at a three-dimensional segmentation contour. Such manual segmentation may be time-consuming and may be imprecise.

Eye organs may be relatively complex. In addition to their complexity, the eye organs may vary from patient to patient. Furthermore, surrounding tissues may also vary from patient to patient. This complexity and variety may complicate the task of a clinician who only wishes to administer RT doses to specific regions.

Thus, there is a need for methods and systems that automatically segment biological structure, such as various organs of sight. Additionally, there is a need for methods and systems that perform segmentation with improved accuracy and speed. There is a need for methods and systems that enable simple, yet efficient and cost-effective segmentation usable for a variety of clinical applications, such as RT.

### BRIEF SUMMARY OF THE INVENTION

### BRIEF DESCRIPTION OF SEVERAL VIEWS OF THE DRAWINGS

FIG. 1 shows organs of sight, in accordance with an embodiment of the present invention.

FIG. 2 shows a flow chart of a method for segmenting biological structure in accordance with an embodiment of the present invention.

FIG. 3 shows a flowchart of a method for segmenting an eyeball, in accordance with an embodiment of the present invention.

FIG. 4 shows a flowchart of a method for segmenting a lens, in accordance with an embodiment of the present invention.

FIG. 5 shows a flowchart of a method for segmenting an optic nerve, in accordance with an embodiment of the present invention.

FIG. 6 shows a flowchart of a method for segmenting a chiasm, in accordance with an embodiment of the present invention.

FIG. 7 shows a graphical representations of organs of sight with seed points, in accordance with an embodiment of the present invention.

FIG. 8 shows an example of segmenting a lens, in accordance with an embodiment of the present invention.

FIG. 9 shows an example of segmenting an optic nerve, in accordance with an embodiment of the present invention.

FIG. 10 shows an example of segmenting an optic nerve, in accordance with an embodiment of the present invention.

FIG. 11 shows an example of segmenting a chiasm, in accordance with an embodiment of the present invention.

FIG. 12 shows a system for performing automatic segmentation, in accordance with an embodiment of the present invention.

The foregoing summary, as well as the following detailed description of certain embodiments of the present application, will be better understood when read in conjunction with the appended drawings. For the purpose of illustrating the invention, certain embodiments are shown in the drawings. It should be understood, however, that the present invention is not limited to the arrangements and instrumentality shown in the attached drawings. Some figures may be representative of the types of images and displays that may be generated by disclosed methods and systems.

### DETAILED DESCRIPTION OF THE INVENTION

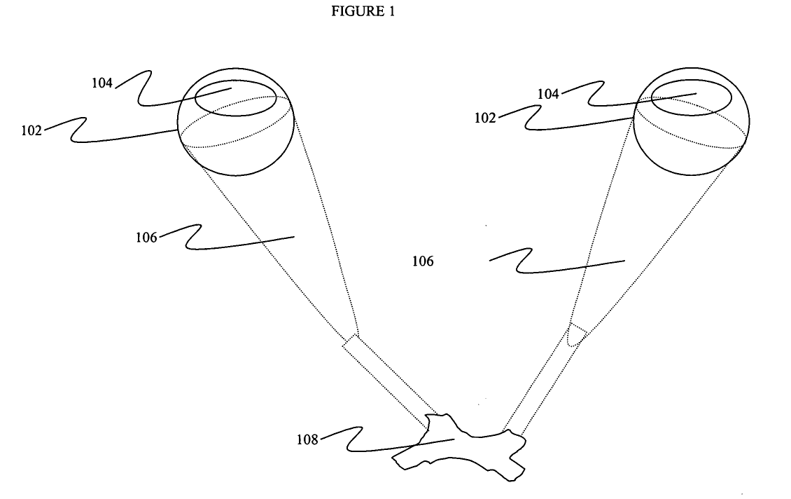

FIG. 1 shows organs of sight 100, in accordance with an embodiment of the present invention. Organs of sight 100 may include, for example, an eyeball 102, a lens 104, an optic nerve 106, and a chiasm 108. Images for organs of sight 100, or a portion thereof, may be generated using radiological modalities, such as x-ray, computed tomography (“CT”), magnetic resonance imaging (“MRI”), and/or positron emission tomography (“PET”), for example. Organs of sight 100 may be imaged as two-dimensional slices, or as a three-dimensional volume. For any given radiological modality, each pixel and/or voxel in a resulting image may have associated grayscale values. Grayscale values may be quantified by Hounsfield Units, or other appropriate measurement system. Particular organs of sight 100 may display grayscale values that may be differentiated from surrounding tissues and/or other organs of sight 100. CT imaging, in particular, may generate radiological images of organs of sight 100 which may be well suited for segmentation as discussed below. However, the segmentation discussed in the present application may be performed on radiological images from any of the various available modalities (e.g. MRI, or PET), and is not particular to images generated by CT imaging.

Segmentation, in accordance with embodiments of the present invention, may employ geometric modeling as will be further discussed. Geometric modeling may involve the fitting of geometric shapes to various components of organs of sight, for example. For example, geometric modeling may involve the fitting of sphere(s), ellipsoid(s), pipe(s), cone(s), and/or the like. Other similar geometric shapes may be substituted for those disclosed. Geometric modeling shapes may be one, two, three, and/or four dimensional (e.g. for the case of non-rigid organs changing over time). A three dimensional shape may be modeled from a series of smaller dimensional shapes (e.g. a pipe may be a series of circles and/or ellipses), for example.

An eyeball 102 may be, for example, a human eyeball. A human's organs of sight 100 may include two eyeballs 102. For a given species, an average shape and size eyeball 102 may be approximated and/or estimated, for example. The average size eyeball 102 may be useful for performing segmentation, as discussed below. An average size eyeball 102 may be substantially spherical with a given radius. For example, an average human eyeball 102 may be substantially spherical with a radius of 12 mm. Further, a radiological image of an eyeball 102 may result in pixels and/or voxels having grayscale values within a particular range.

Turning back to FIG. 1, a lens 104 is generally positioned within an anterior portion of an eyeball 102. One lens 104 may be contained within each eyeball 102. For a given species, an average lens 104 shape and size may be estimated. The average size lens 104 may be useful for performing segmentation, as discussed below. For example, an average human lens 104 shape may be an ellipsoid. For example, such an ellipsoid may have axes having dimensions of 5 mm, 2.3 mm, and 5 mm. Furthermore, an average size of a lens 104 for a given species may be approximated by a ratio between the eyeball 102 and the lens 104. For example, in humans, the ratio between average eyeball 102 size and average lens 104 size may be given by 2.4, 5.2, 2.4 in x, y and z dimensions. Thus, if the eyeball 102 size is known, simple application of the ratio will result in the corresponding expected average lens 104 size. Knowledge of average lens 104 size and shape may be helpful to segmentation as discussed below. Further, a radiological image of a lens 104 may result in pixels and/or voxels having grayscale values within a particular range.

An optic nerve 106 may correspond to each eyeball 102. An optic nerve 106 may generally connect the eyeball 102 to the chiasm 108. For a given species, an optic nerve 106 shape and size may be approximated. The average optic nerve 106 size and shape may be useful for performing segmentation, as discussed below. For example, an average human optic nerve 106 may be roughly approximated by a cone portion and a pipe portion, with the base of the cone portion anchored at the middle of an eyeball 102 and the apex of the cone portion connected to the pipe portion. The other end of the pipe portion may be anchored at the chiasm 108. Knowledge of an average optic nerve 106 size and shape may be helpful to segmentation as discussed below. Further, a radiological image of an optic nerve 106 may result in pixels and/or voxels having grayscale values within a particular range.

Turning back to FIG. 1, a chiasm 108 may also be included as an organ of sight 100. The chiasm 108 may generally resemble the letter “X”. The chiasm 108 may be found in the brain, located above the sella turcica. Because the chiasm 108 may be generally formed from the same types of neural tissues as the surrounding brain, it may be difficult to differentiate the chiasm 108 from nearby regions based on grayscale alone. The chiasm 108 may, however, have an average shape and size for a given species. The average shape and size of a chiasm 108 may be, for example, empirically derived from a number of samples within a species, such as human, for example. An average shape and size of a chiasm 108 may be useful for segmentation as discussed below.

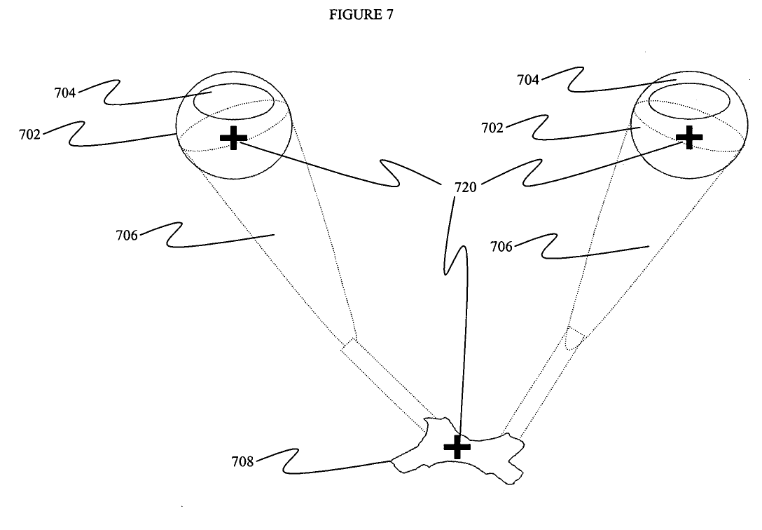

FIG. 7 shows a graphical representation of organs of sight 700 with seed points 720, in accordance with an embodiment of the present invention. Graphical representations of organs of sight 700 may be generated, for example, by a radiological imaging system. Graphical representations of organs of sight 700 may also be generated by model, or by other representations. The graphical representation of organs of sight 700 may correspond, for example, to organs of sight 100, as shown in FIG. 1. Graphical organs of sight 700 may include graphical eyeball(s) 702, graphical lens(es) 704, graphical optic nerve(s) 706, and graphical chiasm 708. A graphical representation 700 may correspond to a patient, a model, or the like. A graphical representation 700 may contain two-dimensional, three-dimensional, and/or four-dimensional data.

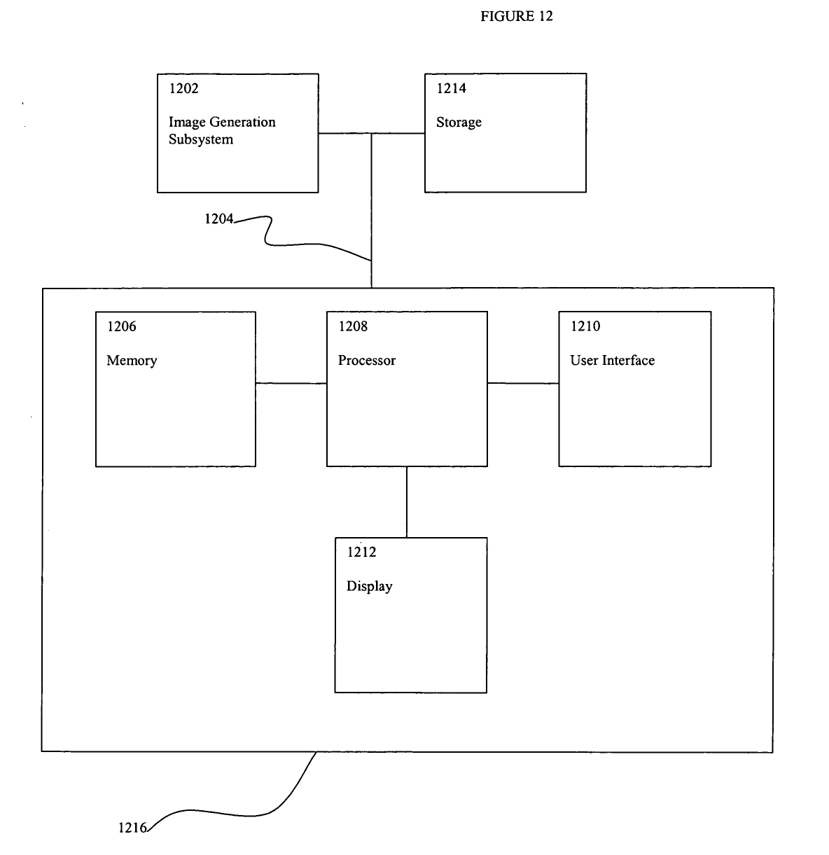

FIG. 12 shows a system for automatically segmenting biological structure, in accordance with an embodiment of the present invention. A system 1200 may include an image generation subsystem 1202 communicatively linked to an image processing subsystem 1216 and/or a storage 1214 through one or more communications links 1204. Components of the system 1200 may be implemented in software, hardware, firmware, and/or the like. Components of the system 1200 may be implemented separately and/or integrated in various forms, for example.

An image generation subsystem 1202 may be any radiological system capable of generating two-dimensional, three-dimensional, and/or four-dimensional data corresponding to a volume of interest of a patient, for example. Some types of image processing subsystems 1202 include computed tomography (CT), magnetic resonance imaging (MRI), x-ray, positron emission tomography (PET), tomosynthesis, and/or the like, for example. An image generation subsystem 1202 may generate one or more data sets corresponding to an image which may be communicated over a communications link 1204 to a storage 1214 and/or an image processing subsystem 1216.

A storage 1214 may be capable of storing set(s) of data generated by the image generation subsystem 1202. The storage 1214 may be, for example, a digital storage, such as a PACS storage, an optical medium storage, a magnetic medium storage, a solid-state storage, a long-term storage, a short-term storage, and/or the like. A storage 1214 may be integrated with image generation subsystem 1202 or image processing subsystem 1216, for example. A storage 1214 may be locally or remotely located, for example. A storage 1214 may be persistent or transient, for example.

An image processing subsystem 1216 may further include a memory 1206, a processor 1208, a user interface, 1210 and/or a display 1212. The various components of an image processing subsystem 1216 may be communicatively linked. Some of the components may be integrated, such as, for example processor 1208 and memory 1206. An image processing subsystem 1216 may receive data corresponding to a volume of interest of a patient. Data may be stored in memory 1206, for example.

A memory 1206 may be a computer-readable memory, for example, such as a hard disk, floppy disk, CD, CD-ROM, DVD, compact storage, flash memory, random access memory, read-only memory, electrically erasable and programmable read-only memory and/or other memory. A memory 1206 may include more than one memories for example. A memory 1206 may be able to store data temporarily or permanently, for example. A memory 1206 may be capable or storing a set of instructions readable by processor 1208, for example. A memory 1206 may also be capable of storing data generated by image generation subsystem 1202, for example. A memory 1206 may also be capable of storing data generated by processor 1208, for example.

A processor 1208 may be a central processing unit, a microprocessor, a microcontroller, and/or the like. A processor 1208 may include more than one processors, for example. A processor 1208 may be an integrated component, or may be distributed across various locations, for example. A processor 1208 may be capable of executing an application, for example. A processor 1208 may be capable of executing any of the method(s) and/or set(s) of instructions in accordance with the present invention, for example. A processor 1208 may be capable of receiving input information from a user interface 1210, and generating output displayable by a display 1212, for example.

A user interface 1210 may include any device(s) capable of communicating information from a user to an image processing subsystem 1216, for example. A user interface 1210 may include a mousing device, keyboard, and/or any other device capable of receiving a user directive. For example a user interface 1210 may include voice recognition, motion tracking, and/or eye tracking features, for example. A user interface 1210 may be integrated into other components, such as display 1212, for example. As an example, a user interface 1210 may include a touch responsive display 1212, for example.

A display 1212 may be any device capable of communicating visual information to a user. For example, a display 1212 may include a cathode ray tube, a liquid crystal diode display, a light emitting diode display, a projector and/or the like. A display 1212 may be capable of displaying radiological images and data generated by image processing subsystem 1216, for example. A display may be two-dimensional, but may be capable of indicating three-dimensional information through shading, coloring, and/or the like.

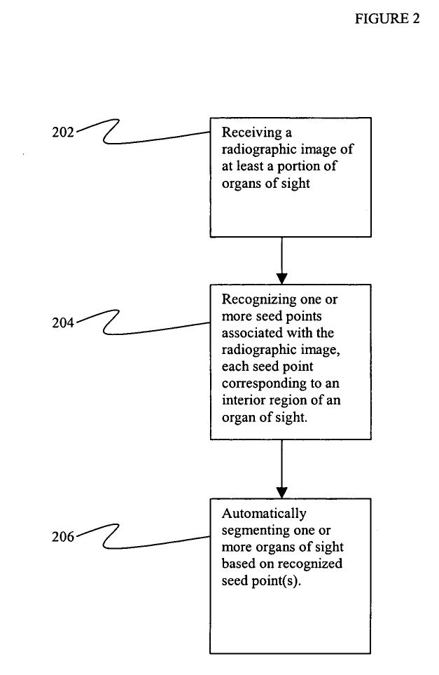

FIG. 2 shows a flow chart of a method 200 for segmenting biological structure (such as organs of sight 100 or representations 700, for example) in accordance with an embodiment of the present invention. At least a portion of steps of method 200 may be performed in an alternate order and/or substantially/partially simultaneously, for example. For example, step 204 may be performed at the same time as step 202, or step 204 may be performed before step 202. Some steps of method 200 may also be omitted, for example. Method 200 may be performed, in whole or in part, by a processor, such as processor 1208 shown in FIG. 12, for example.

At step 202, the method 200 may include receiving a radiographic image of at least a portion of organs of sight 100. For example, a radiographic image may be generated by CT imaging. The image may include at least a portion of organs of sight 100. The image may be a representation of organs of sight 700, as shown in FIG. 7, for example. For example, the image may include an eyeball, lens, optic nerve, and chiasm, similar to those shown in FIG. 1 or FIG. 7. Alternatively, the image may include two eyeballs, two lenses, two optic nerves and a chiasm, similar to those shown in FIG. 1 or FIG. 7. The image may also include biological structure aside from organs of sight 100. For example, the image may also include other portions of the brain, musculature, tendons, vascular tissues, bone, and/or the like. The image may correspond to a human being, for example. Step 202 may be performable by, for example, a processor, such as processor 1208 shown in FIG. 12. Furthermore, the radiographic image, or a copy thereof, may be received and stored in a memory, such as random access memory, for example.

Step 204 may include identifying one or more seed points associated with the radiographic image. The seed point(s) may be integrated into the image data, or may be part of a corresponding set of data. Seed points may be provided by a user, for example. According to an embodiment, a user may select seed points by interacting with a segmentation application by using, for example, a user interface (such as user interface 1210 shown in FIG. 12). Segmentation software may cause a radiographic image, such as one identified at step 202, to be displayed to a user. The user may then, by using a user interface, select seed points to correspond to various areas of the radiographic image. In an embodiment, a user may use a mouse to point and click to form a seed point. Other ways of selecting seed points may also be possible. For example, a user could use stencils, or the like to overlay on the radiographic image, thereby causing the software to generate seed points.

A user may be encouraged to select seed points to facilitate automatic segmentation 206, discussed below, for example. In an embodiment, selection of seed point(s) may select seed point(s) correspond to the interior region of organ(s) of sight 100. Turning for a moment to FIG. 7, a user may interact with a graphical representation 700. For example, a user may select seed point(s) 720 to correspond to various regions of a graphical representation 700. Note, a seed point 720 need not form a part of a graphical representation 700, but may be located with relationship to a graphical representation 700. For example a seed point 720 may be located in the interior of a graphical eyeball 702. The user may further select another seed point 720 to correspond to the interior region of another graphical eyeball 720. Additionally, the user may further select a seed point 720 to correspond to the interior region of a graphical chiasm 708, for example. The seed point(s) 720 may be useable to initialize the automatic segmentation step 206, discussed below. Selected seed point(s) 720 may be integrated into the radiographic image, or may be contained in a separate set of data that corresponds to a radiographic image. Turning back to FIG. 2, after seed point(s) 720 have been selected (for example, by a user as described above), the method 200 may identify the selected seed point(s) 720 at step 204. For example, seed point(s) 720 may be represented by data structures which are readily identifiable by, for example, segmentation software. In addition to geographical information, seed point(s) 720 may contain information that describe which graphical representation(s) of organs of sight 700 each seed point 720 corresponds to. For example, a seed point 720 may contain information that describes a correspondence to a graphical eyeball 702, a graphical chiasm 708, or a location thereof.

A variety of workflows may be possible for a user's of seeds vis-a-vis an automatic segmentation application. In a first workflow possibility, a user provides three seed points at or near the outset, for example. The three seed points may correspond to the interior of graphical eyeball(s), 702 and/or graphical chiasm 708 for example. After selection of three seed points, the application may automatically segment all seven organs of sight, for example. Such an interaction may not require any action after selection of three seed points, for example. The seven organs of sight structures (2 eyeballs, 2 lenses, 2 optic nerves and chiasm) can be automatically organized into a structure group “sight,” for example. Such group structuring in an application may help a user manage anatomically related structures, for example.

In another possible workflow, a user provides seed point(s) one by one and the subsequent results appear in a short time (e.g. substantially in real-time) after provision of a seed point, for example. Providing an eyeball seed point may result the eyeball and the included lens segmentation, for example. Providing a chiasm seed point may result the segmentation of the 2 optic nerves and chiasm, for example. Again, the resulted structures can be organized into a structure group “sight”. It may be preferable if the first and second points are in the eyeball, and the third point is in the chiasm, for example. Under such a preference, an algorithm may check whether a seed point may be provided to an earlier segmented organ, for example. If so, the earlier-segmented organ may be segmented again as discussed above.

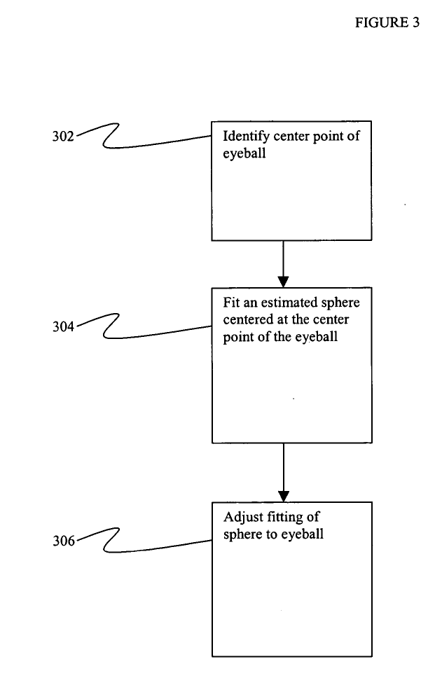

At step 206, the method 200 automatically segments one or more organs of sight 100 (or representations 700 thereof) based on identified seed points from step 204. Organs of sight 100 (or representations 700) may be segmented, for example, on an organ-by-organ basis. Alternatively, organs of sight 100 (or representations 700) may be segmented sequentially (e.g. eyeball, lens, chiasm, optic nerve). Organs of sight 100 (or representations 700) may be segmented in various orders, and/or may be segmented simultaneously with other of organs of sight 100 (or representations 100). Step 206 may include one or more of the various methods disclosed herein, such as methods 300, 400, 500, 600, shown in FIGS. 3-6, for example.

FIG. 3 shows a flowchart of a method 300 for automatically segmenting an eyeball 102, in accordance with an embodiment of the present invention. At least a portion of steps of method 300 may be performed in an alternate order and/or substantially/partially simultaneously, for example. For example, step 304 may be performed at the same time as step 302, or step 304 may be performed before step 302. Some steps of method 300 may also be omitted, for example. Method 300 may be performed, in whole or in part, by a processor, such as processor 1208 shown in FIG. 12, for example. Method 300 may be performable on two-dimensional, three-dimensional, or four-dimensional data, for example.

In an embodiment, a seed point (such as seed point 720 shown in FIG. 7) may be identified as corresponding to an eyeball 102 or an eyeball representation 702 on a radiographic image. The seed point may be useful for directing algorithms used in method 300 to a particular eyeball, for example. Other techniques may also be used for directing method 300 to a particular eyeball, such as a template for mapping a radiological image including organs of sight to an expected region of a particular eyeball, for example.

At step 302, the center point of an eyeball (such as eyeball 102 or 702) may be identified. A center point of an eyeball may be identified by utilizing known intensity properties of eyeballs for a given radiological modality, such as CT, for example. For example, pixels and/or voxels in the center region of an eyeball may be known to have intensity properties within a particular Hounsfield unit range, for example. A center point may be searched for in the region of a seed point, for example, or some other indication or algorithm for determining an expected center of an eyeball, for example.

At step 304, estimated sphere centered at the center point of the eyeball may be fitted. An estimated sphere may be a sphere having a radius corresponding to an average value for a particular species, such as human, for example. The radius may extend from the center point for example. Variations of the sphere may also be possible, such as ellipsoid-like shapes. An estimated sphere may be universal or may be tailored for specific information corresponding to one or more patients (e.g. sex, age, weight, height, pathology, etc.).

At step 306, the fitting of the sphere to an eyeball may be further adjusted. For example, a region corresponding to the center of the eyeball may be searched in the region of the user-given seed point. Two circles may be employed for identifying the center point and the radius of the fitted sphere, for example. A smaller circle may be positioned inside the eyeball, and a larger circle may be positioned outside the eyeball, for example. A wellness measure may be calculated based on the positions of the circles that indicates the accuracy of the sphere positioning, for example. The wellness measure may be substantially minimized by adjusting the locations of the circles, for example. If the wellness measure is substantially minimized, this may result in an accurately identified center point and radius of the fitted sphere, for example. Calculation of wellness values may be facilitated by predefined grayscale values of pixels and/or voxels inside and outside of the eyeball, for example. The sphere may incorporate the adjusted properties (e.g. center point and/or radius), and provide a segmentation of an eyeball, for example.

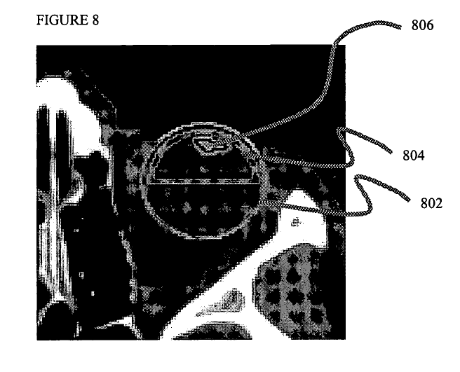

Turning for a moment to FIG. 8, an example of a segmented eyeball is shown in accordance with an embodiment of the present invention. The eyeball is shown segmented by a sphere 802 (shown in two-dimensional view as a circle).

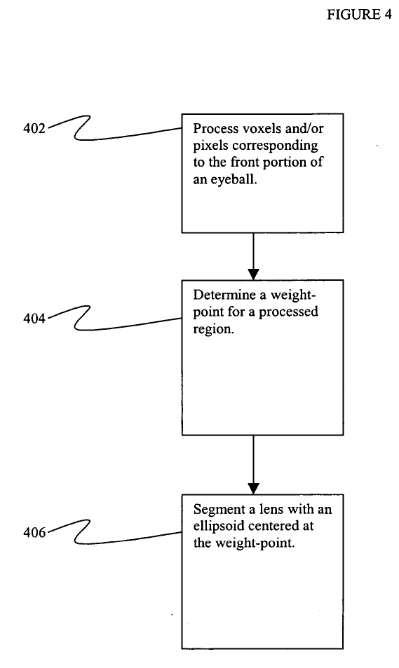

FIG. 4 shows a flowchart of a method 400 for automatically segmenting a lens 104 or a representation 704, in accordance with an embodiment of the present invention. At least a portion of steps of method 400 may be performed in an alternate order and/or substantially/partially simultaneously, for example. For example, step 404 may be performed at the same time as step 402, or step 404 may be performed before step 402. Some steps of method 400 may also be omitted, for example. Method 400 may be performed, in whole or in part, by a processor, such as processor 1208 shown in FIG. 12, for example. Method 400 may be performable on two-dimensional, three-dimensional, and/or four-dimensional data, for example.

At step 402, data corresponding to a front part of an eyeball containing a lens, (such as eyeball 102, or representation 702) may be processed. A front part of an eyeball may be the portion facing outwards (e.g. opposite from the retina). A front part of an eyeball may be identified based on information such as orientation, location, or intensity values of pixels and/or voxels, for example. Data, such as pixels or voxels that correspond to the front part of an eyeball, may be processed by a variety of techniques known in the art, for example. The front (e.g. anterior) part of the eyeball may be thresholded, for example.

The technique of thresholding may entail assigning a particular value to a voxel and/or pixel based on the voxel and/or pixel correspondence to a threshold and/or interval, for example. For example, thresholding may entail assigning a different value to a voxel and/or pixel if it corresponds to a value less than a given threshold, or within a particular interval, for example. For example, thresholding may assign all voxels and/or pixels to be black if they have a gray values greater than a given threshold grayscale value, and to be white if they have a value less than the given threshold grayscale value. Alternately, thresholding may assign some voxels and/or pixels to have a first shade of gray if they are within a given grayscale interval, and other voxels and/or pixels to have a second shade of gray if they are not within a given grayscale interval, for example.

After thresholding, a continuous region (e.g. a particular grayscale region, such as black) resulting from thresholding may be further processed, for example. The data resulting from thresholding may have uniform intensity values for a region corresponding to a lens, for example.

At step 404, a center of gravity, or “weight-point” may be determined for a given processed region. Weight-point determination may be performed on the filtered data, such as data resulting from thresholding, for example. For example, if a region is white, a weight-point may be determined for the white region. The coordinates of the center of gravity and/or weight point may be calculated as follows. A coordinate—geometry technique may be used in the practice; the sum of the x, y, z coordinates for each pixel and/or voxel may be calculated separately, and divided by a total number of voxels and/or pixels in the region. The weight point may correspond to the center of a given region. A weight-point may be in two, three, or four dimensions, for example. The weight point for the filtered (e.g. thresholded) region may correspond to the center point of a lens, for example.

At step 406, a lens, such as lens 104 or representation 704 may be segmented with ellipsoid or other shape centered at the weight-point. A fitted ellipsoid may be two, three, or four dimensional, for example. For example, a lens may be segmented with an ellipsoid that is determined with respect to a segmented eyeball. The ellipsoid for segmenting the lens may be determined from a given ratio, and the known size of a corresponding eyeball. The ratio(s) between the size of the lens and the eyeball may be determined using statistics, for example. For example, the ellipsoid may be oriented as follows: determine a vector from the center of the eyeball to the center of the lens; rotate the fitted ellipsoid such that the vector points along the direction of the rotational axis of the ellipsoid. After fitting of an ellipsoid, the ellipsoid may be further tweaked if necessary to correspond more substantially to filtered data (e.g. data resulting from thresholding), for example. The fitted ellipsoid, or variation thereof, may provide segmentation of a lens, for example.

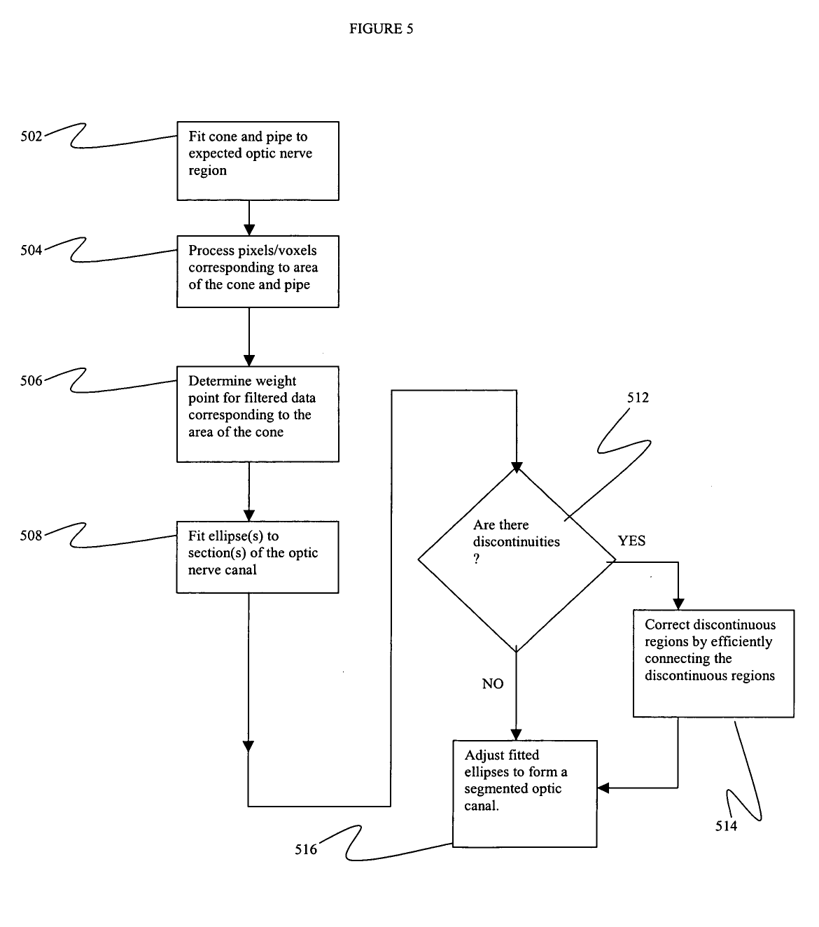

FIG. 5 shows a flowchart of a method 500 for automatically segmenting an optic nerve (such as optic nerve 106 or representation 706, shown in FIGS. 1, 7), in accordance with an embodiment of the present invention. At least a portion of steps of method 500 may be performed in an alternate order and/or substantially/partially simultaneously, for example. For example, step 504 may be performed at the same time as step 502, or step 504 may be performed before step 502. Some steps of method 500 may also be omitted, for example. Method 500 may be performed, in whole or in part, by a processor, such as processor 1208 shown in FIG. 12, for example. Method 500 may be performable on two-dimensional, three-dimensional, and/or four-dimensional data, for example.

At step 502, a cone portion and pipe portion may be fitted to an expected region of an optic nerve. The cone portion may be substantially cone-like, or may otherwise resemble a cone, for example. For example, a cone portion may have a straight or a bent axis, and the apex may be a point or rounded, for example. The pipe portion may be substantially pipe-like, or may otherwise resemble a pipe. For example, a pipe portion may have a uniform radius or a changing radius. A pipe portion may have a straight axis or a bent axis, for example.

The apex of the cone portion may be determined with a plurality of techniques, or an average thereof, for example. According to one technique, a triangle may be gradually extended from the dorsal edge of an eyeball, for example. The triangle may be extended along a coordinate dimension, such as an x-coordinate, for example. As the triangle is extended, it may be checked at every step until the triangle includes bone and/or air pixels and/or voxels, for example. At the point that the triangle contains bone, the apex of the cone may correspond to the extended point of the triangle, for example.

According to another technique, a triangle may be gradually extended along an axis extending from the center of the eyeball to the direction of the seed-point of the optic chiasm, for example. Once the triangle contains bone and/or air, for example, the apex of the cone portion may then correspond to the extended point of the triangle.

The base of the cone may be a circle with a slightly smaller radius than the radius of the eyeball, for example. The center point of the slightly smaller circle may be the center point of the eyeball, for example. The orientation of the slightly smaller circle may be perpendicular to the axis of the cone which runs between the center point of the eyeball and the calculated apex, for example. The apex of the cone portion may connect with one end of the pipe. The other end of the pipe may connect with a chiasm (such as chiasm 108 or 708, for example).

The fitted pipe portion may contain the optic canal, for example. However, it may be preferable that the fitted pipe portion should not be much larger than the optic canal, for example. If the pipe portion is too large, it may include a passageway outside the bony tunnel, which may confuse subsequent modeling algorithms, for example.

One of the end-points of the pipe portion may be at or near the apex of the cone, for example. The other end point of the pipe portion may be determined as follows. A 30 mm by 15 mm area may be selected around the seed-point corresponding to the optic chiasm, for example. The seed-point may be on the dorsal side of the 30 mm×15 mm area and may bisect the area, for example. In this area, pixels and/or voxels may be thresholded. For example, pixels and/or voxels may be thresholded if they are within a grayscale interval and/or attenuation value, such as between −30 HU and 150 HU, for example. A contiguous area containing the seed point may result from thresholding, for example. It may be possible to determine the farthest points of the contiguous area in based on range of angles, for example. The apex of the angle may be the chiasm seed-point, for example, and the range of angles may be between 30-70 degrees, for example. The farthest points within the contiguous area along the angle(s) may be usable as the other end-point for the pipe portion(s), for example.

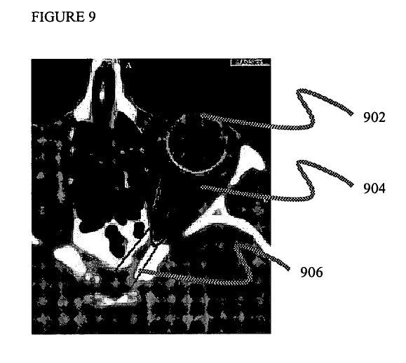

Turning for a moment to FIG. 9, an eyeball 902, cone portion 904, and pipe portion 906 are shown in context with an underlying radiological image of organs of sight, in accordance with step 502. The cone portion 904 is shown connecting the eyeball 902 and the pipe portion 906. The other end of the pipe portion 906 connects with the chiasm 108 (not shown). The cone portion 904 and pipe portion 906 have been fitted to an expected region of an optic nerve.

Turning back to FIG. 5, at step 504, pixels and/or voxels in an area corresponding to the cone and pipe may be processed. For example, the pixels and/or voxels may be thresholded as described in conjunction with method 400. For example, pixels and/or voxels may be assigned a value based on their grayscale intensity values (e.g. Hounsfield values). All pixels and/or voxels above/below a given threshold value may be assigned a common value. After processing, pixels and/or voxels identified as being common may form a region.

The optic nerve area, however, may present difficulties for processing. For example, nearby tissues, such as musculature and other tissues may have similar attenuation values as the optic nerve for particular radiological modalities, such as CT, for example. Thus, it may be relatively difficult to distinguish nerve tissue from non-nerve tissue during processing. Consequently, additional processing may be helpful, if nerve and nearby tissue are not distinguishable through techniques such as thresholding. Thresholding may show potentially optic nerve tissue, for example. As will be discussed, a weight-point determination may provide a better approximation of the actual nerve region.

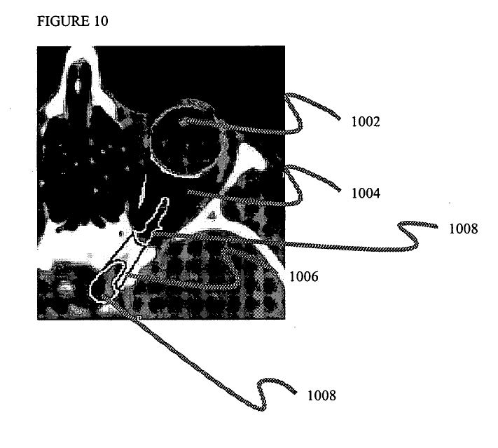

Turning to FIG. 10, an example of processing data in the cone and pipe regions is shown, in accordance with step 504. A cone portion 1004 and pipe portion include three dimensional data (only two dimensional data for a single slice is shown) including nerve tissue. A thresholding algorithm is applied to determine the optic canal. After thresholding, some portions 1008 are identified as being potentially optic nerve tissue. Note, from the view in FIG. 10, it may not be apparent whether the thresholded portions 1008 are continuous, because other portions 1008 may exist in other two dimensional slices (not shown). Thus, it may be seen that processing data may separate some tissues as nerve and non-nerve tissues within the cone and pipe regions, for example.

At step 506, weight point(s) for processed data may be determined. For example, data forming a common region may be processed to determine a weight point. It may be possible to determine a single weight point for a region, or multiple weight points may be determined along various dimensions, such as along a coronal dimension, for example. For example, processed data may be in three dimensions, and may be decomposed into a series of two dimensional coronal slices. A weight point for processed data may be determinable for each coronal slice, for example.

At step 508, ellipse(s) may be fitted to a section of the optic nerve canal. A fitted ellipse may be substantially elliptical, for example, or may otherwise generally resemble an ellipse. For example, a football-type shape (e.g. United States football-type shape) may be fitted, or a bulbous shape may be fitted. A fitted ellipse may be a coronal ellipse, fitted on a coronal plane of the optic nerve canal. Alternatively, an ellipse and/or other shape may be fitted along other planes, such as sagittal, axial, and/or oblique, for example. A first ellipse may be centered at a weight point on the coronal plane, for example. An ellipse may include optic nerve tissue and/or other tissue, for example. A ellipse may have a shape based on an expected size of an optic nerve for a particular region, for example. An expected size of an optic nerve may be universal for a given species (e.g. human), or may vary based on patient factors (e.g. size, sex, weight, height, pathology, etc.). An ellipse may also have a dynamic size depending on the processed data, for example. For example, a fitting algorithm may be able to estimate an ellipse size dynamically based on the processed data (e.g. estimate major/minor axes based on thresholded data for a particular slice). Ellipses may be fitted along the region of processed data from step 504. For example, ellipses may be fitted along a region corresponding to the thresholded part of the fitted cone and pipe. For example, the region may extend, generally, from an eyeball to the chiasm.

At step 512, the fitted ellipses may be checked to determine whether the ellipses form a continuous optic nerve canal connecting an eyeball with the chiasm. The fitted ellipses may form a continuous canal between an eyeball and the chiasm. If so, then method 500 may proceed to step 516, for example. If not, method 500 may proceed to step 514, for example. For example, one or more discontinuities may exist in the fitted ellipses along a dimension, such as a transverse dimension (e.g. a dimension generally running between an eyeball and a chiasm). A discontinuity may be a gap and/or other type of discontinuity, such as a substantial misalignment between ellipses, for example. If such discontinuities exist, it may be helpful to fill in gaps, for example, at step 514. The presence of discontinuities may be determined by a variety of techniques, for example, such as if the ellipse fitting routine cannot reach the end-point of the pipe. The end-point may not be reached, for example, if the optic canal cannot be seen on any traversal plane. In this case the drawing of ellipses on the coronal planes from the end-point of the pipe may be performed from one and/or both sides of the pipe until a tunnel may be completed, for example.

For example, if a particular coronal slice could not be fitted with an ellipse at step 508, such information may be communicated to step 512 so method 500 may take corrective action. As another example, if clinical preferences do not require correction, then method 500 may proceed to step 516, even with the presence of discontinuities.

At step 514, if discontinuities exist among the fitted ellipses, then discontinuous regions may be made continuous by efficiently making a continuous optic nerve canal fitted region.

At step 516, the fitted ellipses may be adjusted to form a segmented optic canal. For example, a shrinking or smoothing algorithm may be employed to smooth out any variances among the ellipses. As another example, the surface of the fitted ellipses may be compared to processed data (e.g. thresholded data), and appropriately adjusted, for example. The fitted ellipses may be adjusted in accordance with any technique employed for adjustment to result in a segmented optic canal. As another example, there may be no clinical preference perform a final adjustment, and this step may be omitted.

The result of ellipse fitting routine may be an approximation of the optic nerve, for example. The segmented shape may be improved with further processing, for example. Using a shrinking algorithm a skeleton of the optic nerve may be determined, for example. It may be possible that the initially fitted region was not continuous, for example. In such a case the skeleton may have two or more parts, for example. Separate parts may be connected with any of a variety of algorithms, including an algorithm that calculates a substantially efficient connection path between non-contiguous portions, for example. After completing the skeleton, the continuous skeleton may be enlarged by a suitable amount to arrive at the final segmented shape of the optic nerve, for example.

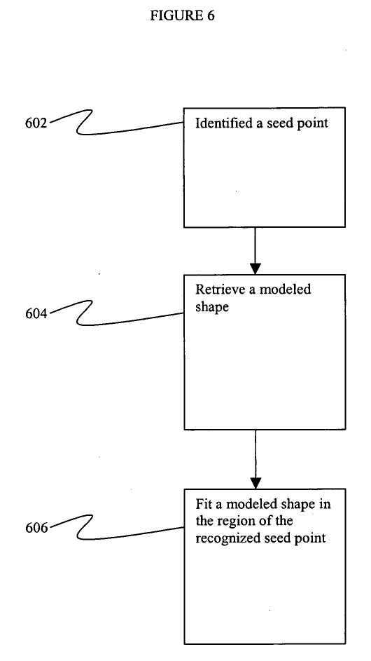

FIG. 6 shows a flowchart of a method 600 for automatically segmenting a chiasm 108 or a representation 708, in accordance with an embodiment of the present invention. At step 602, a seed point, such as seed point 720, is identified. In particular, a seed point in the expected region of the chiasm 108 or 708 may be identified at step 602.

At step 604, a modeled chiasm form may be retrieved. The modeled chiasm form may be two-dimensional or three-dimensional. The modeled chiasm form may be derived from empirical data about the shape of a chiasm. The modeled chiasm form may be derived as an average of surveyed optic chiasm forms. The modeled chiasm form may represent known principles of chiasm formation and orientation. The modeled chiasm form may be modified based on patient information, or may be constant for every given patient. For example, certain factors may influence the size of a chiasm in a patient, such as sex, age, size, race, pathology, and/or the like.

At step 606, the modeled chiasm form may be fitted in the region of the identified seed point. The anterior end-points of the modeled chiasm may be situated near the end point of the pipes, for example. The dorsal end-points of the modeled shape may be determined using a predefined size with respect to the anterior end-points, for example. Additionally, it may be taken into consideration that the shape of the chiasm may not contain the bone of the sella turcica, for example.

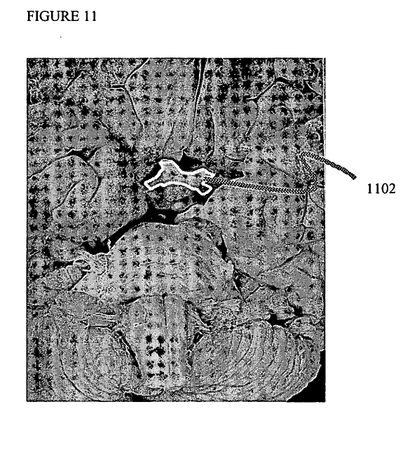

Turning to FIG. 11, an example of chiasm segmentation is shown in accordance with an embodiment of the present invention. A modeled chiasm 1102 is shown fitted with corresponding chiasm structure in an image of a patient's brain.

As an illustrative example, segmentation of organs of sight may be performed in the following manner. Turning to FIG. 12, a processor 1208 is capable of performing methods 200, 300, 400, 500 and 600. The processor 1208 executes at least one segmentation application based on a set of instructions in a computer-readable medium. Turning to FIG. 2, starting with method 200, the processor receives at step 202 an image of a patient's organs of sight including three-dimensional data obtained from a CT scan. Each voxel in the data contains an intensity value. The organs of sight include two eyeballs, two lenses, two optic nerve canals, and a chiasm (as shown in FIG. 7). The processor 1208 displays the image to a user through a display 1212. Turning back to FIG. 2, at step 204, the processor identifies three seed points which have been provided by a user. In this example, the user selects a seed point positioned in three dimensions, based on multiple dimensional views (e.g. coronal, sagittal, and axial) shown to the user at display 1212. The user interacts through a user interface 1210 to select three seed points—one in each eyeball and one in the chiasm. In response, the application running on processor 1208 identifies the three seed points. At step 206, automatic segmentation is performed as a combination of methods 300, 400, 500, and 600, as will be discussed.

Turning to FIG. 3, to execute automatic segmentation, method 300 is performed for each eyeball. At step 302, a center region of each eyeball is identified based on intensity properties for pixels in the expected center region of each eyeball, corresponding to the location of the user-provided seed point. A thresholding filter and a weight-point algorithm is applied to the identified center-region to determine a center point. Next, at step 304, a sphere having a radius average for a human is fitted to each eyeball. Next, at step 306, the accuracy of each fitted sphere is adjusted to conform to the actual eyeballs. Pixels around the expected surface area of each eyeball are thresholded to determine the actual outer surface of each eyeball. Each sphere is then substantially adjusted to the calculated shape for each eyeball.

Turning to FIGS. 4 and 8, after eyeball segmentation, lens segmentation for each lens is performed by the processor 1208 in accordance with method 400. At step 402, voxels in a front portion of each eyeball (shown as 804 in FIG. 8) are thresholded using expected CT intensity properties for an eyeball and lens. Thresholding results in a common area 806 (one for each eyeball)) which should correspond to a lens. At step 404, a weight point is determined for common area 806. At step 406, ellipsoids are fitted to each lens based on the calculated weight point. The fitted ellipsoid has a known size based on a ratio with the patient's eyeball size. The fitted ellipsoid is located based on a best-fit determination corresponding to common area 806.

Turning to FIGS. 6 and 11, chiasm segmentation is performed next, in accordance with method 600. At step 602, the user-defined seed point in the region of the chiasm is identified. At step 604, a model of a chiasm is retrieved. In this example, the model is a universal model for humans. At step 606, the shape is fitted to the region of the user-defined seed point. This completes segmentation of the chiasm.

Turning to FIG. 5, optic nerve segmentation is performed next, in accordance with method 500. At step 502, a cone and pipe portions are fitted to each of the optic nerve expected regions between the eyeballs and the chiasm. Next, at step 504, the voxels within the cone and pipe regions are thresholded to separate nerve and non-nerve tissues. Next at step 506, a weight point for the nerve tissue is determined for each coronal slice along the processed data from step 504. Next, coronal ellipses are fitted to the thresholded data along each coronal slice. The ellipses are centered at the weight point calculated at step 506. Next, at step 512, it is detected that there is a discontinuity along the canal based on a gap. So, at step 514, the gap is filled with a algorithm that connects the shortest distance across the gap, and interpolates intermediate ellipse dimensions based on the end-point ellipses of the gap. Finally, at step 516, a smoothing algorithm is applied to the series of coronal ellipses to arrive at the final optic nerve canal segmentations (one for each optic nerve).

After segmentation of two eyeballs, two lenses, the chiasm, and two optic nerves, the patient's organs of sight have been substantially segmented. A clinician may use the automatically generated segmentation for further clinical purposes.

Turning to FIG. 12, in an embodiment, system 1200 includes a computer-readable medium, such as a hard disk, floppy disk, CD, CD-ROM, DVD, compact storage, flash memory and/or other memory. The medium may be in an image processing subsystem 1216 (e.g. in processor 1208 and/or memory 1206) and/or in a separate system. The medium may include a set of instructions capable of execution by a computer or other processor. The methods 200, 300, 400, 500, and/or 600 described above may be implemented as instructions on the computer-readable medium, for example. For example, the set of instructions may include a reception routine that receives a radiographic image including organs of sight. Additionally, the set of instructions may include an identification routine that identifies one or more seed points. Additionally, the set of instructions may include a segmentation routine for automatically segmenting at least one of the organs of sight based at least in part on the at least one seed point.

Thus, embodiments of the present application provide methods and systems that automatically segment biological structure, such as various organs of sight. Additionally, embodiments of the present application provide methods and systems that perform segmentation with improved accuracy and speed. Moreover, embodiments of the present application provide methods and systems that enable simple, yet efficient and cost-effective segmentation usable for a variety of clinical applications, such as RT.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. For example, features may be implemented with software, hardware, or a mix thereof. Therefore, it is intended that the invention not be limited to the particular embodiment disclosed, but that the invention will include all embodiments falling within the scope of the appended claims.

1. A method for segmenting biological structure comprising:
identifying at least one seed point associated with a radiographic image, wherein said radiographic image includes at least one organ of sight, said at least one seed point positioned to correspond to an interior region of said at least one organ of sight; and
automatically segmenting said at least one organ of sight based at least in part on said at least one seed point.

2. The method of claim 1, wherein said automatically segmenting at least one of said organ of sight comprises geometrical modeling with at least one shape.

3. The method of claim 1, wherein a first of said at least one seed point corresponds to an interior region of a first eyeball and a second of said at least one seed point corresponds to an interior region of a second eyeball.

4. The method of claim 2, wherein automatically segmenting said at least one organ of sight further comprises:
identifying a center point of said eyeball;
positioning said at least one shape at said center point;
adjusting said at least one shape based at least in part on grayscale values in said eyeball.

5. The method of claim 4, wherein said at least one shape comprises a sphere having a predefined radius.

6. The method of claim 5, wherein automatically segmenting said at least one organ or sight further comprises:
processing data portions corresponding to the front portion of an eyeball to form a processed region;
determining a weight point for at least a portion of said processed region; and
segmenting at least one lens with said at least one shape centered at said weight point.

7. The method of claim 6, wherein said at least one shape comprises an ellipsoid having a predefined ratio with respect to an eyeball size.

8. The method of claim 1, wherein one of said at least one seed point corresponds to a region of a chiasm.

9. The method of claim 8, wherein automatically segmenting said at least one organ or sight further comprises fitting a chiasm shape to a region corresponding to said chiasm.

10. The method of claim 2, wherein automatically segmenting said at least one organ of sight further comprises:
fitting a first said at least one shape along an expected region of an optic nerve;
processing data corresponding to a region of said first said at least one shape to form processed data;
determining at least one weight point corresponding to a section of said processed data; and
fitting a second said at least one shape centered at said at least one weight point to form a segmented optic nerve.

11. The method of claim 10 further comprising determining a skeleton of said segmented optic nerve and expanding said skeleton to form an adjusted segmented optic nerve.

12. The method of claim 10 further comprising connecting at least two non-contiguous sections said segmented optic nerve to form a contiguous segmented optic nerve.

13. The method of claim 11 further comprising connecting at least two non-contiguous sections said skeleton to form a contiguous skeleton.

14. The method of claim 10, wherein said first said at least one shape comprises a cone portion and a pipe portion.

15. The method of claim 10, wherein said second said at least one shape comprises at least one ellipse.

16. The method of claim 1, wherein a user is capable of selecting said at least one seed point.

17. The method of claim 16, wherein said user selects said at least one seed point in substantially in accordance with a workflow.

18. A computer-readable storage medium including a set of instructions for a computer, the set of instructions comprising:
a reception routine for receiving a radiographic image comprising one or more organs of sight;
an identification routine for identifying at least one seed point associated with said radiographic image, said at least one seed point positioned to correspond to an interior region of at least one of said one or more organs of sight; and
a segmentation routine for automatically segmenting at least one of said one or more organs of sight based at least in part on said at least one seed point.

19. The set of instructions of claim 18, wherein said segmentation routine further comprises:
an identification routine for identifying a center point of an eyeball;
a location routine for locating a sphere having a predefined radius at said center point; and
an adjustment routine for adjusting said sphere to substantially conform to processed data along an expected surface of said eyeball.

20. The set of instructions of claim 18, wherein said segmentation routine further comprises:
a processing routine for processing data portions corresponding to a front portion of an eyeball to form a processed region;
a determination routine for determining a weight point for at least a portion of said processed region; and
a segmentation routine for segmenting said at least one lens with an ellipsoid centered at said weight point.

21. The set of instructions of claim 18, wherein said segmentation routine further comprises a fitting routine for fitting a modeled shape to a region corresponding to a chiasm.

22. The set of instructions of claim 18, wherein said segmentation routine further comprises:
a fitting routine for fitting a cone portion and pipe portion along an expected region of at least one optic nerve;
a processing routine for processing data corresponding to a region of said cone portion and said pipe portion;
a determination routine for determining at least one weight point corresponding to a section of said processed data; and
a fitting routine for fitting at least one ellipse centered at said at least one weight point to form a segmented optic nerve.

23. A system for performing automatic segmentation of organs of sight comprising:
a processor capable of receiving an image comprising at least one organ of sight, said processor further capable of identifying at least one seed point corresponding to at least one of said at least one organ of sight,
wherein said processor is capable of automatically segmenting said at least one organ of sight based at least on said image and said at least one seed point.

24. The system of claim 23 further comprising a user interface for facilitating a selection of said at least one seed point by a user.
